(19) United States
(12) Patent Application Publication
(10) Pub. No.: US 2008/0181091 A1
(43) Pub. Date: Jul. 31, 2008

(54) OPTICAL DISC DRIVE

(75) Inventors: Hiroshi Nakane, Fukaya-shi (JP); Kazumi Sugiyama, Kawasaki-shi (JP); Yoshinori Tazaki, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/022,615

(22) Filed: Jan. 30, 2008

(30) Foreign Application Priority Data
Jan. 31, 2007 (JP) 2007-022256

(51) Int. Cl. G11B 7/00

(52) U.S. Cl. 369/124.01; 369/44.11; 369/284

(57) ABSTRACT

According to one embodiment, a device which identifies the types of recording media different in recording density including, a light source which outputs light at a predetermined wavelength, a photodetector which detects reflected light from one information recording layer of a recording medium having at least two information recording layers provided with a first recording density or a second recording density higher than the first recording density, a lens which condenses the light from the light source to present a minimum spot on one of the information recording layers of the recording medium, and a signal processing circuit which acquires a component containing characteristics peculiar to the information recording layer of the recording medium having the second recording density out of the reflected light detected by the photodetector.

### CROSS-REFERENCE TO RELATED APPLICATIONS

This application is based upon and claims the benefit of priority from Japanese Patent Application No. 2007-022256, filed Jan. 31, 2007, the entire contents of which are incorporated herein by reference.

### BACKGROUND

1. Field

One embodiment of the invention relates to an optical disc drive device for recording information on an optical disc or reproducing information recorded on an optical disc, and a method of distinguishing between the standards of optical discs.

2. Description of the Related Art

It has been a long time since information recording media capable of recording and reproducing information using laser light, that is to say, optical discs were first put to practical use. With regard to optical disc standards, a digital versatile disc (DVD) standard has appeared following a compact disc (CD) standard, and an HD DVD standard which has further increased the density of the DVD standard is already in practical use. In addition, types are defined in each disc standard, such as “-ROM” meaning playback only, “-R” meaning being only recordable once, “-RAM” meaning being rewritable. Moreover, a type called “-RW” is defined as a rewritable type in the DVD standard.

When the optical disc of the CD standard alone was practically used, it was possible to use, for a focus detection system, an optical system having the same numerical aperture (NA) as that of a laser element (laser diode) at the same wavelength, and it was possible to use, for a tracking (error) detection system, a three-beam system in playback-only equipment and a DPP (PP system) system in recording/playback equipment in order to record and reproduce information.

The optical disc of the DVD standard appeared, there was a demand from the market for playback-only equipment and recording/playback equipment compatible with both the CD standard and the DVD standard, and an optical disc drive device was required to be able to differentiate between the optical discs of the two kinds of standards. In addition, it is known that there is a difference between the CD standard and the DVD standard in the wavelength of laser light to be used due to the difference in substrate thickness and due to the difference of recording density, and there is also a difference of the NA of an objective lens, track pitch, pit size or demodulation algorithm, leading to a problem of an increased time required before the start of recording or reproduction conforming to the kind of an optical disc.

However, since there is a difference in the substrate thickness, that is to say, in the distance to a recording layer between the optical disc of the CD standard and the optical disc of the DVD standard, a problem of the differentiation between the CD standard and the DVD standard has been already solved by detecting the substrate thickness.

In contrast, the substrate thickness of the optical disc of the HD DVD standard which has been recently put to practical use is 0.6 mm and is the same as that of the optical disc of the DVD standard, so that it is difficult to differentiate between these standards by the method which has been used to detect the difference of the substrate thickness in order to distinguish between the optical disc of the CD standard and the optical disc of the DVD standard.

It is known that when laser light of a predetermined wavelength is applied to one of the recording layers of such an optical disc having two or more recording layers, reflected laser light is generated from the recording layer being in focus, and reflected laser light is additionally generated from the remaining recording layer and emerges as a noise component.

For example, Japanese Patent Application Publication (KOKAI) No. 2006-31773 has disclosed that, in addition to a first photodetection unit for detecting the light reflected from one of two or more information recording layers, and a second photodetection unit composed of one or more light receiving surfaces is additionally mounted on a light receiving element to detect stray light from the other information recording layer, such that the number of information recording layers stacked on an optical disc is identified on the basis of the intensity of the stray light detected by the second photodetection unit, and an optical pickup is controlled before focus servo control in accordance with the identified number of information recording layers.

Although the Publication No. 2006-31773 shows the detection of the stray light from the other information recording layer to identify the number of the other information recording layers, it does not however describe noise (interference noise) generated by the light reflected from the other information recording layer. Moreover, identifying the number of the other information recording layers is completely different from distinguishing between the standards of optical discs having the same thickness.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc drive device according to an embodiment of the invention;

FIG. 2 is an exemplary diagram showing an example of outputs of light receiving areas of a photodetector (PD) incorporated in a PUH of the optical disc drive device, and a focus error signal and a tracking error signal shown in FIG. 1, according to an embodiment of the invention;

FIG. 3 is an exemplary diagram showing an example of a part usable for noise detection shown in FIG. 2, according to an embodiment of the invention;

FIGS. 4A and 4B are exemplary diagrams each showing an example of the relationship between reflected laser light from a recording surface of an optical disc and the position of an objective lens in a track direction shown in FIG. 1, according to an embodiment of the invention;

FIGS. 5A to 5C are exemplary diagrams each showing an example of the relationship between the light receiving areas of the PD and the reflected laser light from the recording surface of the optical disc shown in FIGS. 4A and 4B, according to an embodiment of the invention;

FIGS. 6A and 6B are exemplary diagrams each showing an example of an output signal when reflected laser light from any one of recording surfaces of an optical disc which is provided with two or more recording surfaces is received by the PD shown in FIG. 1, according to an embodiment of the invention;

FIGS. 6C to 6F are exemplary diagrams each showing an example of an output signal when the reflected laser light from any one of the recording surfaces of the optical disc which is provided with two or more recording surfaces is received by the PD shown in FIG. 1, according to an embodiment of the invention;

FIGS. 7A and 7B are exemplary diagrams each showing an example of the relationship between the pitch of groove tracks of optical discs which are substantially equal in the distance to a recording layer (thickness of transparent substrate) but different in standard (recording density), and the spot size of laser light to be applied, according to an embodiment of the invention;

FIG. 8 is a flowchart explaining an example of a method of differentiating between the optical discs which are substantially equal in the distance to the recording layer (thickness of transparent substrate) but different in standard (recording density), according to an embodiment of the invention;

FIGS. 9A to 9C are exemplary diagrams each showing an example of control for actually moving the position of the objective lens shown in FIG. 8, according to an embodiment of the invention;

FIG. 10 is a flowchart explaining an example of a method of differentiating between the optical discs which are substantially equal in the distance to the recording layer (thickness of transparent substrate) but different in standard (recording density), according to an embodiment of the invention;

FIG. 11 is a flowchart explaining an example of a method of differentiating between the optical discs which are substantially equal in the distance to the recording layer (thickness of transparent substrate) but different in standard (recording density), according to an embodiment of the invention;

FIG. 12 is a flowchart explaining an example of a method of differentiating between the optical discs which are substantially equal in the distance to the recording layer (thickness of transparent substrate) but different in standard (recording density), according to an embodiment of the invention;

FIG. 13 is an exemplary diagram showing an example of actual output waveforms of a DPP signal, an LVL signal and an MPP signal obtained by use of the PD shown in FIGS. 4A and 4B, according to an embodiment of the invention; and

FIG. 14 is an exemplary diagram showing an example of actual output waveforms of a DPP signal, an LVL signal and an MPP signal obtained by use of the PD as a result of applying a lens shift shown in FIGS. 4A and 4B, according to an embodiment of the invention.

### DETAILED DESCRIPTION

Various embodiments according to the invention will be described hereinafter with reference to the accompanying drawings. In general, according to one embodiment of the invention, an optical disc optical disc drive comprising: a light source which outputs light at a predetermined wavelength; a photodetector which detects reflected light from one information recording layer of a recording medium having at least two information recording layers provided with a first recording density or a second recording density higher than the first recording density; a lens which condenses the light from the light source to present a minimum spot on one of the information recording layers of the recording medium; and a signal processing circuit which acquires a component containing characteristics peculiar to the information recording layer of the recording medium having the second recording density out of the reflected light detected by the photodetector, and thereby identifies the recording density of the recording medium.

An embodiment of this invention will be described in detail with reference to the drawings.

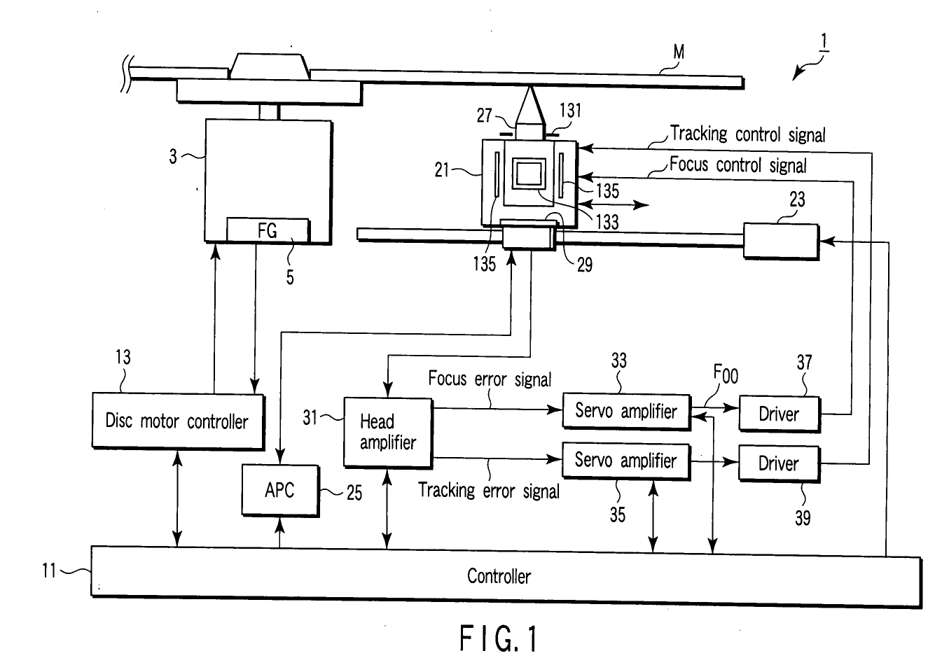

FIG. 1 is a schematic block diagram explaining one example of an optical disc drive device to which the embodiment of the invention is applied.

As shown in FIG. 1, an optical disc drive device 1 has a disc motor 3 for holding an optical disc M and rotating it at a predetermined rotation number. Thus, the optical disc M is rotatably attached to the disc motor 3, and rotated at a predetermined velocity in recording of information on the optical disc M and in reproduction of information from the optical disc M.

The disc motor 3 is equipped with a frequency generator (FG) 5 for generating a signal in accordance with an angle of rotation, so that the rotation of the disc motor 3, that is to say, the optical disc M can be detected.

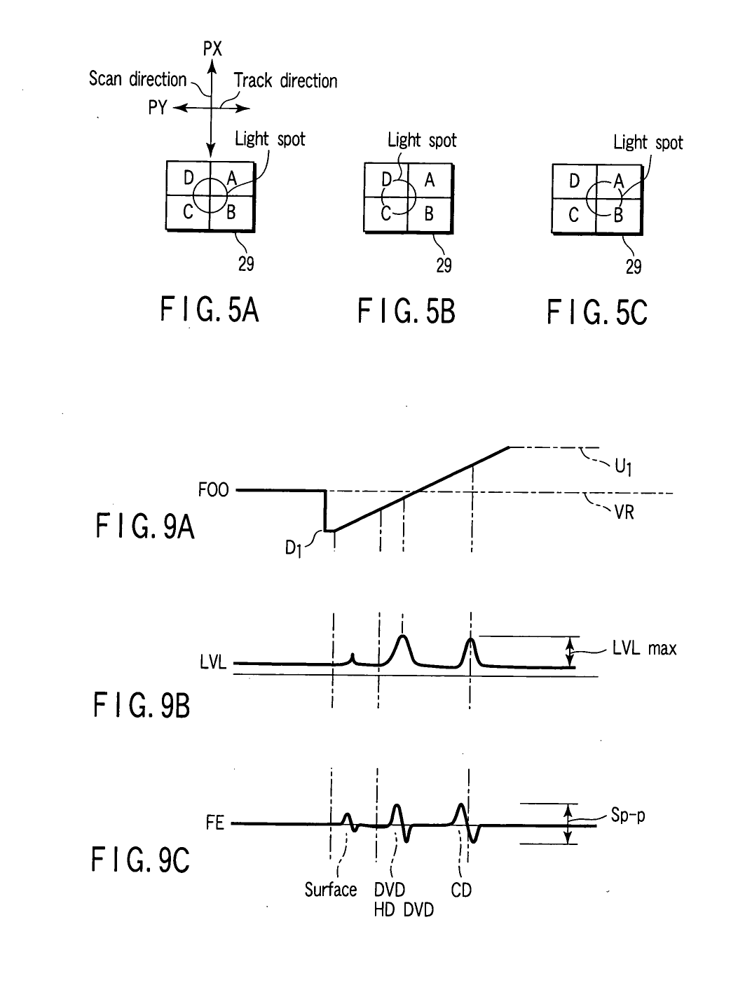

The FIG. 5 generally uses an induced voltage of a field coil of a stator or an output of a hall element for detecting the rotation angle of a magnet of a rotor. About 18 output signals (pulse signals) can be obtained, for example, per rotation by the FG 5.

An FG signal output from the FG 5 is divided by an unshown divider and formed into one-rotation signal, and then input to a controller 11 as an FG₁. In addition, the controller 11 is also supplied with an FG₀ signal which uses the FG signal as it is.

The controller 11 compares an internal reference frequency (reference clock) with the FG₀ signal, and uses a resulting error signal to set a rotation direction and a rotation number of the disc motor 3, for which the controller 11 supplies a motor control signal to a disc motor controller 13 (which controls the rotation of the disc motor 3).

Provided at a predetermined position of the optical disc drive device 1 is a pickup (PUH) 21 which faces an information reading/recording surface (hereinafter, a recording layer) of the optical disc M supported by the disc motor 3 and rotated at a predetermined velocity and which is moved back and forth along the radial direction of the optical disc M. The PUH 21 is located at a predetermined position in the radial direction of the optical disc M by a feed motor 23 (movement of the PUH 21 is controlled by the feed motor 23). In addition, a stepping motor, for example, is used for the feed motor 23.

Although not shown, the PUH 21 is detected by a PUH home detection switch that it is located at the predetermined position when the PUH 21 is moved at a position opposite to the inner peripheral side of the optical disc M.

The PUH home detection switch uses this position as an initial setting of the position (initial position) of the PUH 21.

For example, assume that a position detected by the PUH home detection switch is located at a 25 mm radius of the optical disc M. With a change gear ratio at which one rotation of the feed motor (stepping motor) 23 moves the PUH 21 3 mm, an SLO signal (motor drive signal) is supplied from the controller 11 to the motor 23 by way of an unshown motor driver only for one rotation (of the feed motor 23) after the detection by the PUH home detection switch, such that the position of the PUH 21 is moved over the radius of the optical disc M equal to 28 mm.

Although not described in detail, the PUH 21 includes a first laser element (laser diode) capable of outputting laser light at a wavelength of 405 nm used for recording information on an optical disc of an HD DVD standard and for reproducing information from this optical disc, a second laser element (laser diode) capable of outputting laser light at a wavelength of 655 nm used for recording information on an optical disc of a DVD standard and for reproducing information from this optical disc, and a third laser element (laser diode) capable of outputting laser light at a wavelength of 780 nm used for recording information on an optical disc of a CD standard and for reproducing information from this optical disc. In addition, the third laser element corresponding to the optical disc of the CD standard can be omitted. Moreover, the first and second laser elements may be a double wavelength element contained in the same package.

Hereinafter described mainly are the first laser element which outputs the laser light at a wavelength of 405 nm corresponding to the optical disc of the HD DVD standard and the second laser element which outputs the laser light at a wavelength of 655 nm corresponding to the optical disc of the DVD standard.

The first laser element and the second laser element of the PUH 21 are not simultaneously turned on and used. A monitor diode for monitoring laser outputs is thus in common use, and one set of the monitor diode is only incorporated at a predetermined position of the PUH 21.

A drive current supplied to the individual laser element is controlled by an automatic power control (APC) 25 so that the output of the monitor diode is at a predetermined value.

Furthermore, under the control of the controller 11, the first and second laser elements are switched (the two laser elements are set to on or off) via the APC 25, or the laser outputs are changed.

The selected laser light output from one of the laser elements is converted by an unshown diffraction grating into three beams including zero-order light passing substantially in the center of the diffraction grating in an non-diffracted state and a pair of ± first order lights diffracted by the diffraction grating and formed on both sides of the zero-order light, which beams are guided to an objective lens 27 via a predetermined optical component provided within the PUH 21.

The laser light guided to the objective lens 27 is condensed on a focal position specified by the numerical aperture (NA) inherent in the objective lens 27. At this point, when the distance between the objective lens 27 and the recording surface of the optical disc M coincides with the focal position specified by the NA, the state of focus is onfocus (just focus, in focus). In addition, the spot size of the laser light condensed by the lens 27 is about 0.55 μm in the recording surface of the optical disc M of the HD DVD standard, and about 0.94 μm in the recording surface of the optical disc M of the DVD standard in the case of the zero-order light, that is to say, a main beam (by use of the single lens 27 with a constant NA).

Reflected laser light from the recording surface of the optical disc M is captured by the objective lens 27, and is applied, via a predetermined optical component within the PUH 21, to a quartered light receiving surface of a detector (PD) 29 provided with four light receiving areas split by, for example, two dividing lines perpendicular to each other. In addition, the PD 29 may be integrally provided with an APC detection area for the previously mentioned APC 25. Although not described in detail, a focus error signal is acquired by an astigmatic method and a tracking error signal is acquired by a push-pull system in the PUH 21 shown in FIG. 1.

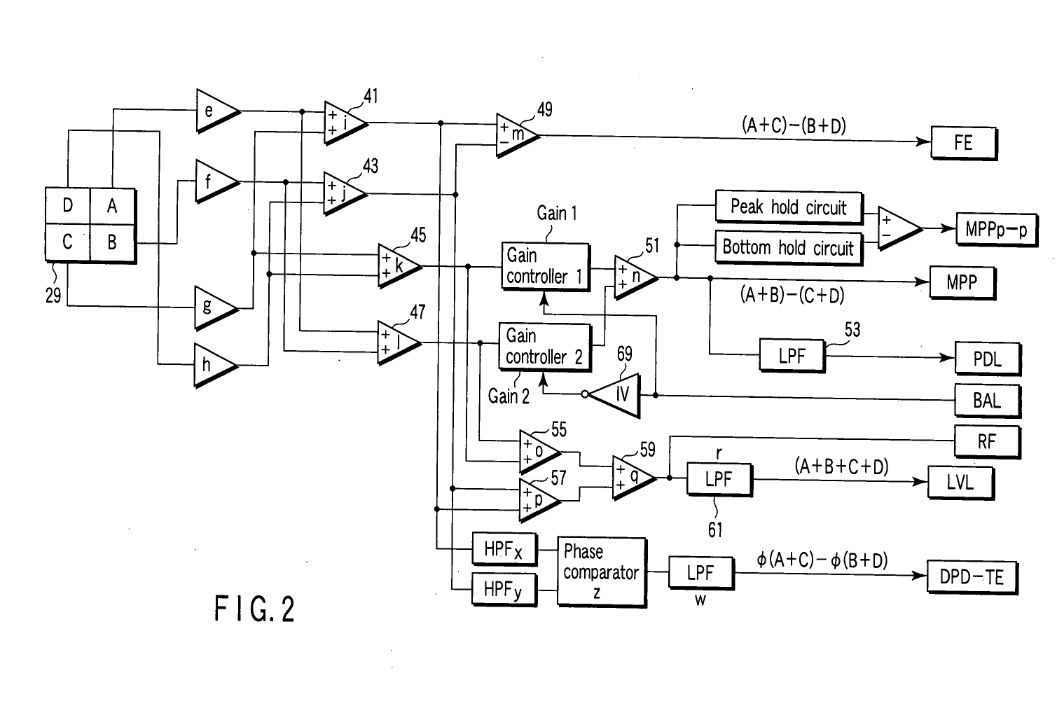

Although not described in detail, the reflected laser light (component) applied to the individual light receiving area of the PD 29 is converted from a current to a voltage by an integrally provided I/V amplifier, and supplied to a head amplifier 31. In addition, processing of an output signal output from the head amplifier 31 will be described later using FIGS. 2, 3, 4A, 4B, 5A to 5C, 6A to 6F.

The objective lens 27 is supported by an unshown wire or thin leaf spring at a predetermined position within the PUH 21 while being held by a lens holder 131.

A predetermined number of coils or magnets are arranged in the lens holder 131. Magnets or coils are also provided at predetermined positions of the PUH 21 to correspond to the coils or magnets provided in the lens holder 131. Thus, the lens holder 131 can be repelled and attracted by a magnetic field from the magnets or coils provided in the PUH 21 such that the lens holder 131 is movable by a predetermined distance in a direction (focus direction) perpendicular to the recording surface of the optical disc and in a radial direction (track direction) of the optical disc.

It is assumed in this embodiment that the coils are provided on the lens holder 131 side and the magnets are provided on the PUH 21 side. Moreover, an operation unit movable in two directions and composed of the lens holder 131 holding the objective lens 27, and a focus control coil 133 and a track control coil 135 that are provided in the lens holder 131 is called a biaxial actuator.

The objective lens 27 is supported by the lens holder at the predetermined position within the PUH 21 owing to the unshown wire or thin leaf spring, such that the objective lens 27 is movable in the direction (focus direction) perpendicular to the recording surface of the optical disc and in the radial direction (track direction) of the optical disc. In addition, control of the position of the objective lens 27 in the focus direction is called focusing, while control of the position of the objective lens 27 in the track direction is called tracking. Further, a signal for driving a focus coil 125 is a focus drive signal, while a signal for driving a tracking coil 127 is a tracking drive signal. Each of the signals is supplied from the head amplifier 31 to a driver 37, 39 via a servo amplifier 33, 35 having a predetermined characteristic. It goes without saying that the amount of control supplied to the servo amplifier 33, 35 is set by the controller 11.

FIG. 2 is a schematic diagram explaining outputs of light receiving areas of the photodetector (PD) incorporated in the PUH of the optical disc drive device shown in FIG. 1, and the focus error signal and the tracking error signal.

If the respective quartered light receiving areas of the PD 29 are referred to as A to D clockwise, outputs corresponding to the light (reflected laser light) received in the respective light receiving areas are subjected to voltage conversion by corresponding current-voltage (I-V) amplifiers e to h, and defined as the focus error signals and the tracking error signals by the computation shown below.

The computing equations are defined by the following:

FE=(A+C)−(B+D)
. . . focus error

TE(MPP)=(A+D)−(B+C)
. . . push-pull (PP) tracking error

TE(DPD)=φ(A+C)−φ(B+D)

φ is a phase (coefficient)
. . . DPD (phase difference) tracking error

LVL=A+B+C+D
. . . reproduction (RF) output

TE(DPP) is not explained.

In addition, the degree of amplification of each part and the frequency of a filter is controlled by the controller 11.

Furthermore, in FIG. 2, an MPPp-p signal indicates the amplitude of the MPP signal, a PDY signal indicates the position of a spot on the PD 29 in the track direction, and an RF diverging between an adder (q) 59 and an LPF (low-pass filter, (r)) 61 indicates an information reproducing signal. In addition, the RF is supplied to an unshown reproduction signal generating unit (a DVD demodulator in the case of the optical disc of the DVD standard or an HD DVD demodulator in the case of the optical disc of the HD DVD standard) connected at a subsequent stage and then used for the generation of a reproduction signal, and also supplied to an unshown address signal processing circuit provided at a subsequent stage and then used to acquire address information previously recorded on the optical disc M.

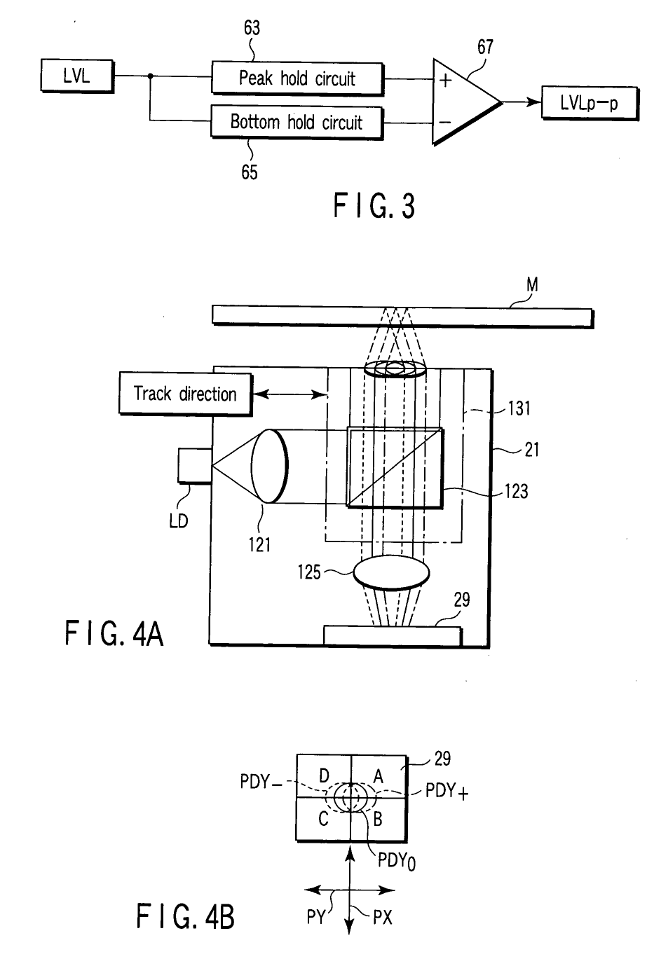

FIG. 3 is a schematic diagram in which a part usable for noise detection explained below is extracted from the signal processing block shown in FIG. 2.

Regarding the outputs of the I-V amplifiers e to h corresponding to the four light receiving areas A to D of the PD 29, the outputs of the two light receiving areas which are not adjacent to each other are added together in an adder (i) 41, an adder (j) 43, an adder (k) 45, an adder (l) 47. Then, outputs of the adders 41 and 43 are added together in an adder (o) 55, and outputs of the adders 45 and 47 are added together in an adder (p) 57. Finally, outputs of the adders 55 and 57 are added together in an adder (q) 59.

An output of the adder 59 is restricted to a predetermined frequency or less in its band by the LPF (r) 61, and output as the above-mentioned “LVL”.

A peak value and a bottom value (i.e., p-p) of the LVL are specified by a peak hold circuit 63 and a bottom hold circuit 65, and the LVL is subtracted in a subtracter 67 and thus output as an LVLp-p signal.

It goes without saying that the focus error signal (FE) is generated by a subtracter (m) 49.

Next will be described using FIGS. 4A and 4B laser light condensed on the recording surface of the optical disc via the PUH of the optical disc drive device shown in FIG. 1, and reflected laser light from the recording surface. In addition, FIG. 4A shows extracted essential parts of the PUH of the optical disc drive device shown in FIG. 1, and FIG. 4B shows the positional relationship between the light receiving surface of the PD and a spot in FIG. 4A.

The laser light exiting from any one of the laser elements (LD) is converted into parallel light by a collimator lens 121, and reflected by a polarizing prism 123 and thus oriented toward the recording surface of the optical disc M. The laser light oriented toward the recording surface of the optical disc M is given predetermined condensing properties by the objective lens 27, and present a minimum spot at a predetermined distance from the main plane of the objective lens 27.

When the objective lens 27 is positioned to focus on the recording surface of the optical disc M (i.e., onfocus), characteristics of the wave front of the laser light are changed in accordance with information recorded on the recording surface of the optical disc M, such that the laser light is again returned as reflected laser light to the objective lens 27 (when the objective lens is focused on the recording surface, reflected laser light in which the presence of a recording mark indicating the recorded information is traced can be obtained by the laser light applied onto the recording surface).

The reflected laser light returned to the objective lens 27 passes through the polarizing prism 123, and is given predetermined imaging properties by an imaging optical system 125 including, for example, an astigmatic lens and then applied to the PD (quartered detector) 29.

At this point, spot light (reflected laser light) on the PD 29 moves between a set of the light receiving areas A and B and a set of the light receiving areas c and d in accordance with the position of the objective lens 27 in the track direction in a situation where the four light receiving areas of the PD 29, that is to say, two splitting lines PX and PY are set in the scan direction (tangential direction of the track) and track direction of the optical disc M, respectively, as shown in FIGS. 5A to 5C.

It goes without saying that the PD 29 may be a bisected photodetector provided with at least two detection areas split by the splitting line PX. In other words, the PD 29 has only to be able to detect the difference between the reflected lights from the optical discs M with respect to a direction perpendicular to the direction in which the track or groove (guide groove) or the recording mark (pre-pit) line formed in the optical disc M extends. Moreover, it goes without saying that the detection areas of the PD 29 do not have to be adjacent to each other and may be spaced at a predetermined distance specified by the imaging properties of the imaging optical system or by a combination with a wave front dividing element including, for example, a hologram element (HOE) and grating.

In addition, the movement of the above-mentioned spot leads to the PDY obtained by passing the addition result (push-pull signal) by an adder (n) 51 shown in FIG. 2 through an LPF (low-pass filter) 53. Moreover, it goes without saying that the state of the spot shown in FIG. 4B is specifically an arbitrary state between “PDY₋” shown in FIG. 5B and “PDY₊” shown in FIG. 5C and is “PDY₀” as shown in FIG. 5A when there is no deviation in the track direction.

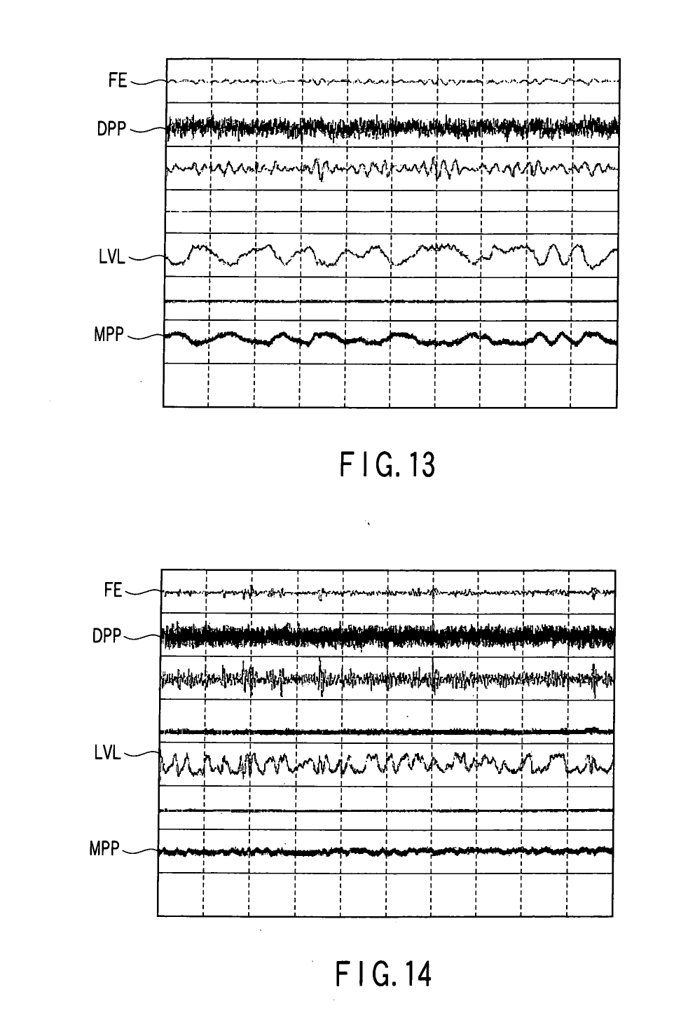

In addition, FIGS. 13 and 14 show an example of a focus error (FE) obtained from the output of the PD 29, and waveforms of a DPP signal, an LVL signal and an MPP signal which are obtained by subjecting the output of the PD to predetermined computation. FIG. 13 shows a case where there is “no” known lens shift which displaces (inclines) the objective lens 27 in a predetermined amount in the track direction (radial direction of the disc). FIG. 14 shows a case where the lens shift is applied to the objective lens 27, that is to say, a case where the lens shift is “on”. In FIGS. 13 and 14, the comparison of the MPP proves that noise components are reduced (FIG. 14) when the lens shift is “on”.

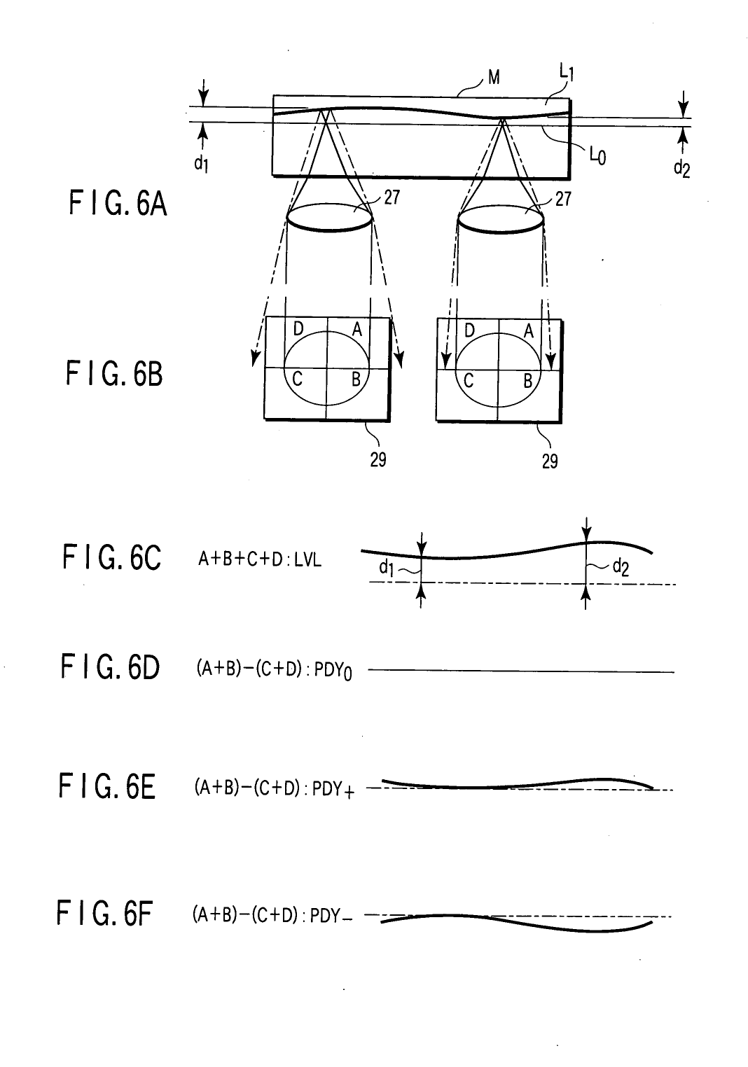

Next will be described using FIGS. 6A and 6B laser light condensed on the recording surface of the optical disc via the PUH of the optical disc drive device shown in FIG. 1, and reflected laser light from any one of recording surfaces of an optical disc which is provided with two or more recording surfaces. In addition, FIG. 6A shows extracted essential parts of the PUH of the optical disc drive device shown in FIG. 1, and FIG. 6B shows the positional relationship between the light receiving surface of the PD and a spot in FIG. 6A.

As is apparent from FIGS. 6A and 6B, the laser light focused on a recording layer L₀ closer to the objective lens (substrate side) also reaches a (second) recording layer L₁ distant from the objective lens, and part of the laser light is condensed on the light receiving surface of the PD 29 as the reflected laser light. In this case, when there are an interlayer distance d₁ and an interlayer distance d₂ smaller than d₁ (thickness of intermediate layer is uneven), the intensity of the reflected laser light returning from the recording layer L₁ having the distance d₂ is higher (FIG. 6C). In other words, a shorter interlayer distance leads to stronger returning light.

On the other hand, the reflected laser light from the L₀ (substrate side) may interfere with the reflected laser light from the (second) L₁ in the light receiving surface of the PD due to the difference of their optical path lengths. In other words, the reflected laser lights from two or more recording layers may change intensity and emerge as noise depending on their phases.

Furthermore, in the optical disc M, the interlayer distances of the recording layers vary depending on the positions within the surface of the optical disc M, in particular on radial positions.

Therefore, as shown in FIGS. 6D to 6F, of the PDY signals acquired as MPP signals “(A+B)-(C+D)”, no signal of the returning light emerges in the case of the PDY₀ as shown in FIG. 6D, but returning light components emerge in the case of the PDY₊ (FIG. 6E) and the PDY₋ (FIG. 6F). This signal is added as noise to all the results of calculations of the outputs of the light receiving areas of the PD 29. This inconveniently degrades detection accuracy in a distinguishing method based on the tracking signal. In addition, FIGS. 6A and 6B show a case where noise is caused due to the reflected laser light from the second recording layer L₁ when focus servo is carried out for the recording layer L₀ on the substrate side (objective lens 27 is focused), but it goes without saying that noise is also caused due to the reflected laser light from the recording layer L₀ on the substrate side when focus servo is carried out for the second recording layer L₁ (objective lens 27 is focused).

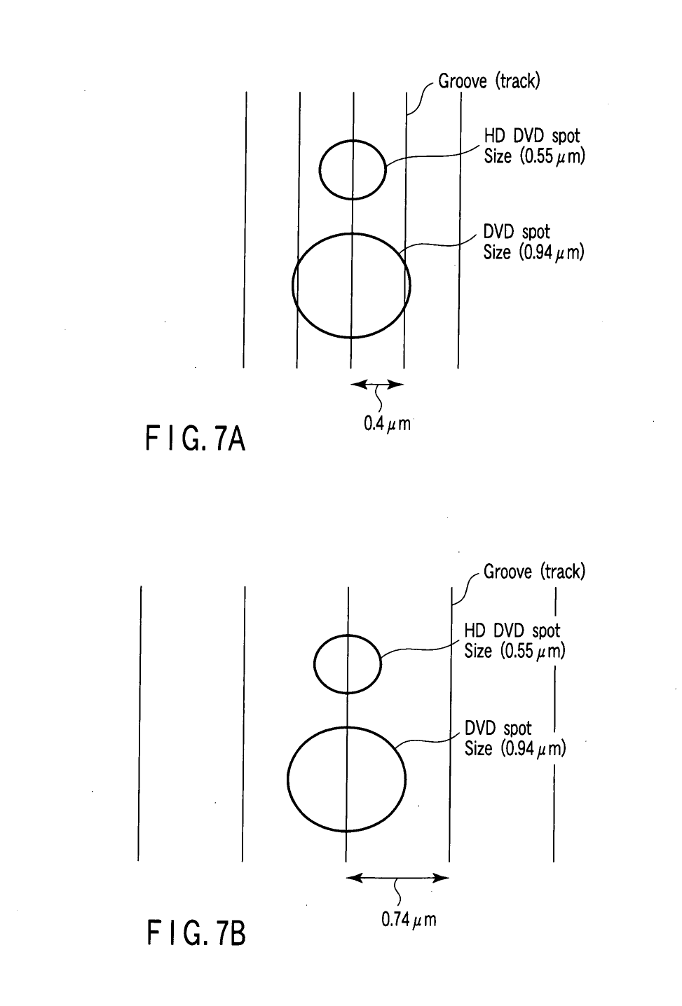

Meanwhile, laser lights of predetermined spot sizes corresponding to the optical disc of the HD DVD standard and the optical disc of the DVD standard which are substantially equal in the distance to the recording layer (thickness of transparent substrate) are applied to these optical discs. In this case, in the optical disc of the HD DVD standard, if the laser light for the optical disc of the DVD standard is condensed thereon, the spot of the laser light is also inevitably applied to the tracks on both sides of the central track because the track pitch is about 0.40 μm as shown in FIG. 7A. In other words, when the laser light of the spot size for the optical disc of the DVD standard is applied to the optical disc of the HD DVD standard, at least two tracks are located within the spot of the laser light.

This means that the amplitude of the tracking error signal is extremely decreased or can not be practically detected. In addition, the amplitude variation of an RF signal traversing the track and the degree of change of the reflected signal are significantly reduced as compared with those arising from the spot of the laser light originally directed to the HD DVD.

Consideration will be given to using this fact to detect by the application of the laser light for the optical disc of the DVD standard whether the standard of the optical disc set in the optical disc drive device shown in FIG. 1 is the DVD standard or the HD DVD standard.

Although described already with reference to FIGS. 6A to 6F, when the focus servo is carried out for the first layer of the optical disc having two or more recording layers, for example, having two recording layers, noise as shown in FIG. 6E or 6F is most evidently generated in the output of the MPP (see FIG. 1) in the case where the wavelength of the laser light is designed for the optical disc of the DVD standard (655 nm) and the set optical disc is of the HD DVD standard (noise emerges in the RF signal and the tracking error signal when the laser light for a low-density optical disc is focused on a high-density optical disc). In addition, noise emerges synchronously with one rotation of the optical disc M.

As described with FIGS. 6A to 6F, the above-mentioned noise is attributed to the reflected laser light leaking from the unfocused layers of the optical disc having two or more recording layers. In addition, the above-mentioned noise noticeably emerges especially when a multi-focal objective lens is used. The noise is also noticeable when the interlayer distance (thickness of intermediate layer) varies during one rotation of the optical disc.

This means that the reduction of the noise generated due to the reflected laser light reflected from the above-mentioned unfocused layer and due to the variation of the interlayer distance makes it possible to more easily differentiate between the optical disc of the HD DVD standard and the optical disc of the DVD standard that are substantially equal in the distance to the recording layer (thickness of transparent substrate).

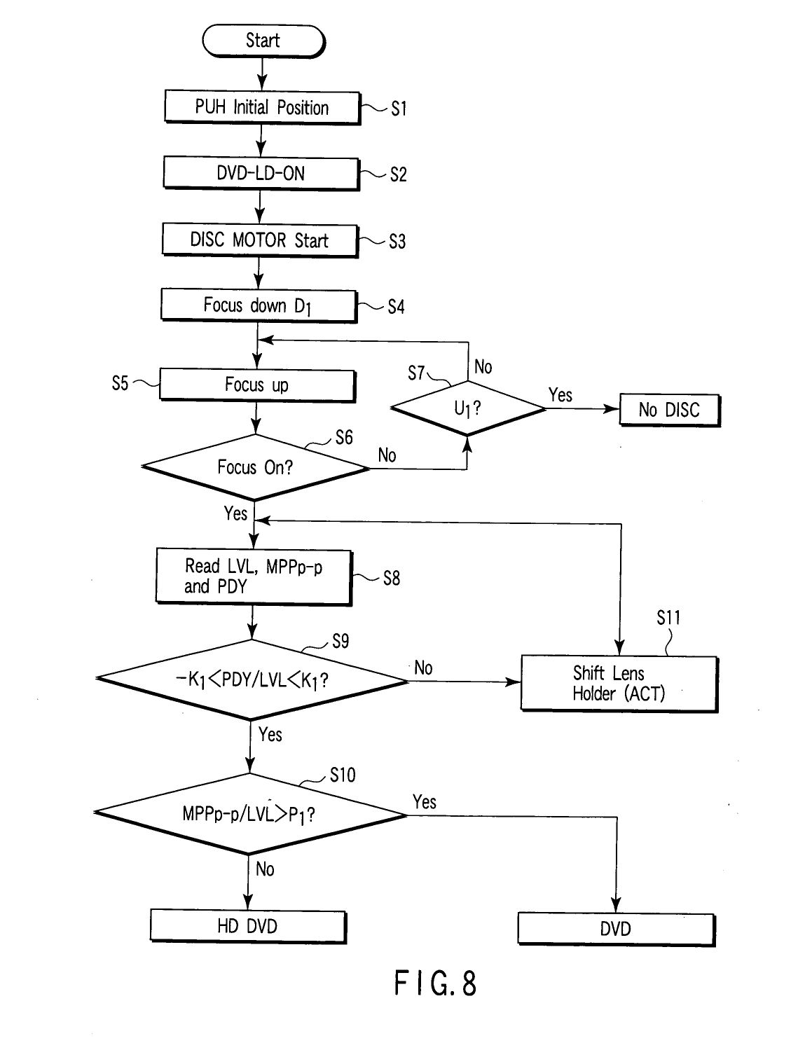

Specifically, as shown in FIG. 8, the PUH 21 is moved to the position of the PUH home switch by the feed motor 23 (S1).

Then, the laser element (wavelength of 655 nm) for the optical disc of the DVD standard is turned on (S2).

Further, the disc motor 3 is rotated at predetermined velocity (S3).

Then, a drive current of a predetermined polarity is supplied to the focus coil 133 of the lens holder 131 holding the objective lens 27, and the objective lens 27 (biaxial actuator) is once moved away because it has been assumed that a recording layer is present when the optical disc M is set, and then the objective lens 27 is gradually moved toward the recording layer (objective lens 27 is moved closer after once being moved away as shown in FIGS. 9A to 9C, S4 to S7).

In addition, in FIG. 9A, F₀₀ indicates the drive current supplied to the focus coil 133, D₁ indicates a current value at which the objective lens 27 (lens holder 131) is most distant (in a control range), and U₁ indicates a current value at which the objective lens 27 (lens holder 131) is closest to the optical disc (in the control range).

Furthermore, as is apparent from FIGS. 9B and 9C, the objective lens 27 is focused at the position (distance) of the surface of a support (transparent substrate) of the optical disc M and at the positions (distances) the HD DVD/DVD standard optical disc (a substrate thickness of 0.6 mm) and the CD standard optical disc (a substrate thickness of 1.2 mm), but erroneous recognition of the substrate surface as the recording surface can be eliminated by checking the LVL.

In addition, when focus-on is not achieved even if the above-mentioned F₀₀, that is to say, the value of the current supplied to the focus coil 133 is changed within a predetermined range (D₁ to U₁) (S7—YES), it is judged that no optical disc is attached.

On the contrary, when focus-on is achieved at an arbitrary current value (S6—YES), the LVL, MPPp-p and PDY signals that have already been described with FIG. 2 are measured for at least one rotation of the disc (S8).

Then, PDY/LVL is found from the obtained signal, and judged whether it is greater than or equal to −K₁ and less than or equal to K₁ (S9).

If PDY/LVL is greater than or equal to −K₁ and less than or equal to K₁ in step S9 (S9—YES), MPPp-p/LVL is then found and compared with a predetermined value P₁ (S10).

If MPPp-p/LVL is less than or equal to P₁ in step S10, it is judged that the optical disc M set on the disc motor 3 is the optical disc of the HD DVD standard (S10—NO).

In addition, if PDY/LVL is less than or equal to −K₁ and greater than or equal to K₁ in step S9 (S9—YES), the drive current of the predetermined polarity is supplied to the track coil 135 of the lens holder 131 in a direction to reduce the PDY signals until PDY/LVL is greater than or equal to −K₁ and less than or equal to K₁ (S11→S8→S9). It should be understood that a drive limit is provided and driving is not continued up to the point where optical performance is not maintained, so that the optical disc is judged as the optical disc of the DVD standard.

Moreover, driving is stopped at −K₁ or more and K₁ or less, and the optical disc is judged as an HD DVD (S11→S8→S9→S10).

In this manner, according to the embodiment of the present invention, the types of arbitrary optical discs equal in the thickness of the substrate in which the recording layers are formed can be differentiated from each other in a short time in accordance with focus-on of the objective lens 27 and arbitrary movement of the objective lens 27 in the track direction without reproducing data recorded thereon.

Moreover, it is possible to separate, with a simple configuration and with accuracy, a signal in the recording layer being focused from the noise (interlayer noise) coming from other recording layers which is inevitable especially when using a multifocal pickup (PUH) having one objective lens alone designed to record information on or reproduce information from three kinds of optical discs different in format including the CD standard, the DVD standard and the HD DVD standard.

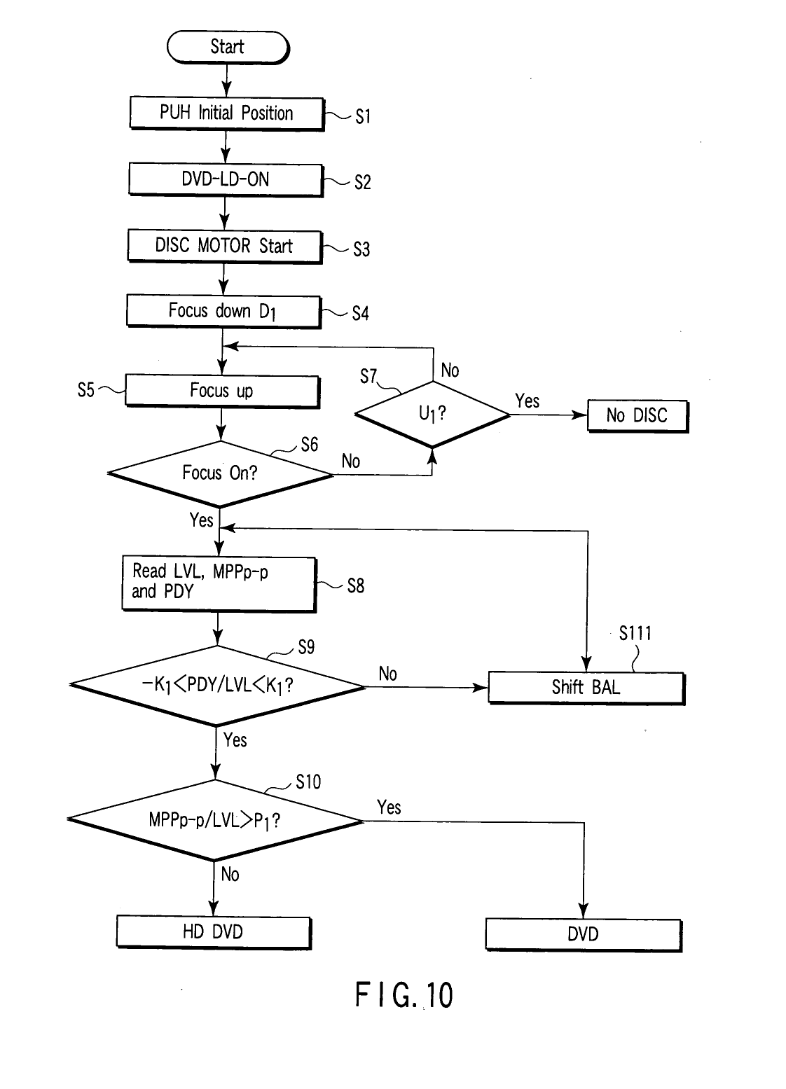

FIG. 10 shows one example of another embodiment for differentiating between the optical disc of the HD DVD standard and the optical disc of the DVD standard described with FIG. 8 which are substantially equal in the distance to the recording layer (thickness of transparent substrate). It is to be noted that the same step numbers are given to the same explanation (steps) as that shown in FIG. 8 and part of the explanation is omitted.

First, the PUH 21 is moved to the position of the PUH home switch by the feed motor 23 (S1), and the laser element (wavelength of 655 nm) for the optical disc of the DVD standard is turned on (S2).

Then, the disc motor 3 is rotated at predetermined velocity (S3), and a drive current of a predetermined polarity is supplied to the focus coil 133 of the lens holder 131, and then the objective lens 27 is gradually moved toward the recording layer after once moved away therefrom (S4 to S7).

When focus-on is not achieved even if the value of the current supplied to the focus coil 133 is changed within a predetermined range (D₁ to U₁) (S7—YES), it is judged that no optical disc is attached.

On the contrary, when focus-on is achieved at an arbitrary current value (S6—YES), the LVL, MPPp-p and PDY signals are measured for at least one rotation of the disc (S8). Then, PDY/LVL is found from the obtained signal, and judged whether it is greater than or equal to −K₁ and less than or equal to K₁ (S9).

If PDY/LVL is greater than or equal to −K₁ and less than or equal to K₁ in step S9 (S9—YES), MPPp-p/LVL is then found and compared with a predetermined value P₁ (S10). If MPPp-p/LVL is less than or equal to P₁, it is judged that the optical disc M set on the disc motor 3 is the optical disc of the HD DVD standard (S10—NO).

On the contrary, if PDY/LVL is less than or equal to −K₁ and greater than or equal to K₁ in step S9 (S9—YES), a BAL signal shown in FIG. 2 is arbitrarily set by simultaneously changing the set values of a gain controller 1 (Gain 1) and a gain controller 2 (Gain 2) input to a previous stage of the LPF 53 for obtaining the PDY signal, that is to say, the adder 51 for obtaining the MPP. In addition, the BAL signal is input to the Gain 1 as it is, and input to the Gain 2 via an inverter 69. Thus, of the two inputs to the adder 51, for example, the Gain 2 is decreased when the Gain 1 is increased.

For example, when the PDY signal is PDY₊, the BAL signal is set higher (an absolute value is increased), which makes it possible to obtain effects equal to when the (C+D) signal of the output of the PD 29 is increased and the (A+B) signal is decreased. In addition, the PDY signal can be monitored to know an appropriate intensity of the BAL signal.

According to this method, factors such as deviation from the track which makes it impossible to maintain optical performance can be eliminated, so that it is possible to more stably distinguish between the optical disc of the HD DVD standard and the optical disc of the DVD standard than in the method shown in FIG. 8 where the lens holder 131 is actually moved in the track direction.

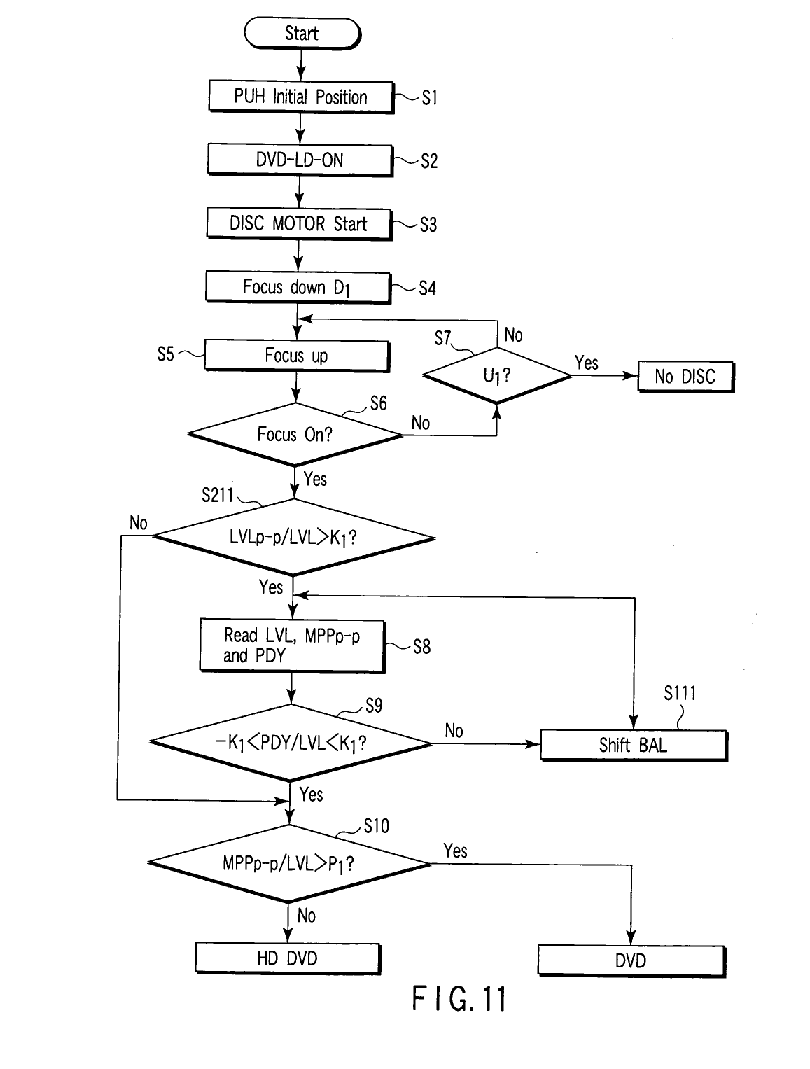

FIG. 11 shows one example of an embodiment for differentiating between the optical discs in a shorter time in the method of differentiating between the optical disc of the HD DVD standard and the optical disc of the DVD standard described with FIG. 10 which are substantially equal in the distance to the recording layer (thickness of transparent substrate). It is to be noted that the same step numbers are given to the same explanation (steps) as that shown in FIG. 8 and part of the explanation is omitted. However, in the example shown in FIG. 11, LVLp-p/LVL is compared with the predetermined value K₁ in a step before step S8 in the flow shown in FIG. 10 (FIG. 8) where “the LVL, MPPp-p and PDY signals are measured for at least one rotation of the disc”, and if the noise level already described with FIG. 6C is less than or equal to the predetermined value (K₁), the flow proceeds directly to step S10 where “MPPp-p/LVL is found and compared with the predetermined value P₁” (S211).

According to this method, the judgment of PDY/LVL can be omitted, such that it is possible to differentiate between the optical disc of the HD DVD standard and the optical disc of the DVD standard in a shorter time.

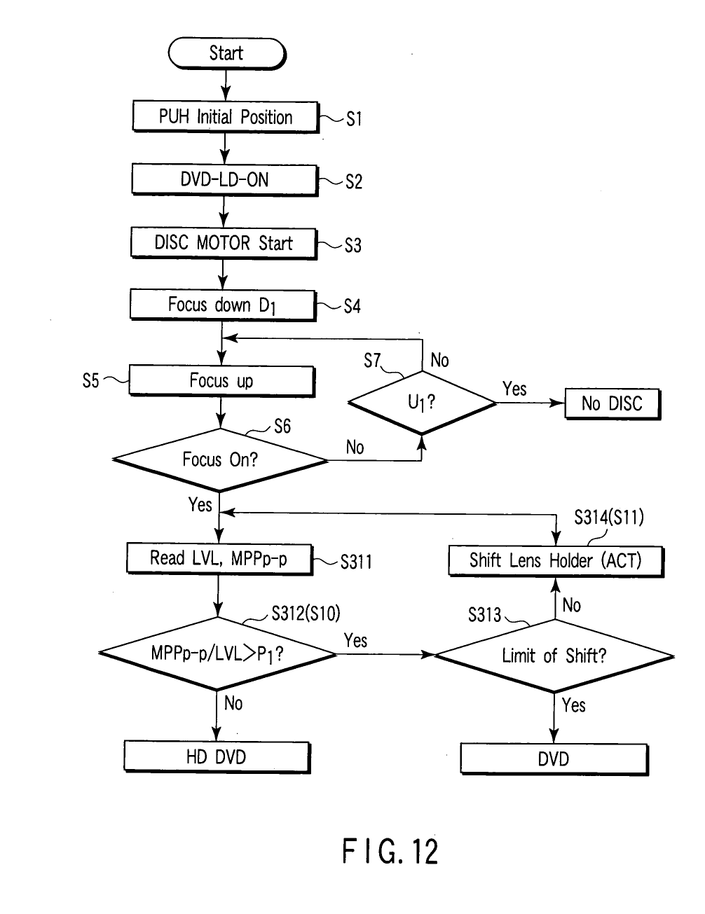

FIG. 12 shows one example of an embodiment for differentiating between the optical discs in a shorter time in the method of differentiating between the optical disc of the HD DVD standard and the optical disc of the DVD standard described with FIG. 8 which are substantially equal in the distance to the recording layer (thickness of transparent substrate). It is to be noted that the same step numbers are given to the same explanation (steps) as that shown in FIG. 8 and part of the explanation is omitted.

According to FIG. 12, as in FIG. 8, when focus-on is achieved at an arbitrary current value (S6—YES), the LVL and MPPp-p are measured during at least one rotation of the disc (S311), and MPPp-p/LVL is generated accordingly and compared with the predetermined value P₁ (S312).

In addition, when MPPp-p/LVL is greater than the predetermined value P₁, the lens holder 131 is moved in the track direction within the limits (S313, S314).

According to this method, the judgment of PDY/LVL can be omitted, and a period (number of times) that the objective lens 27 (lens holder 131) is moved in the track direction to repeatedly find the LVL and MPPp-p is restricted, such that it is possible to differentiate between the optical disc of the HD DVD standard and the optical disc of the DVD standard in a shorter time.

In other words, in the method shown in FIG. 12, a range (an upper limit and a lower limit) is previously set for the amount of movement of the lens holder in the track direction shifted (set) in step S9—NO→S11 in the disc differentiating method shown in FIG. 8, and a value found by MPPp-p/LVL is compared with P₁ within this range. When the value is not P₁ or less, the target optical disc is judged not to be of the DVD standard.

According to this method, the time required to identify the standard of the optical disc is reduced as compared with the method described with FIG. 8.

As described above, according to the embodiment of this invention, the types of arbitrary optical discs equal in the thickness of the substrate in which the recording layers are formed can be differentiated from each other in a short time in accordance with focus-on of the objective lens and arbitrary movement of the objective lens in the track direction without reproducing data recorded thereon.

In particular, it is possible to recognize, in a short time and with accuracy, the difference of standard, that is to say, of recording density of the optical discs provided with two or more recording layers.

Moreover, the laser light used to reproduce information from an optical disc with low recording density is employed to distinguish the recording densities, so that there is no risk of damaging information that is already recorded.

Furthermore, the objective lens, that is to say, the actuator has only to be at least in focus, so that even when an optical disc of an unidentified standard is reproduced, damage to the disc caused by undesired driving of the actuator is practically prevented.

Therefore, it is possible to separate, with a simple configuration and with accuracy, a signal in the recording layer being focused from the noise (interlayer noise) coming from other recording layers which is inevitable especially when using a multi-focal pickup (PUH) having one objective lens alone designed to record information on or reproduce information from three kinds of optical discs different in format including the CD standard, the DVD standard and the HD DVD standard.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc drive comprising:
a light source which outputs light at a predetermined wavelength;
a photodetector which detects reflected light from one information recording layer of a recording medium having at least two information recording layers provided with a first recording density or a second recording density higher than the first recording density;
a lens which condenses the light from the light source to present a minimum spot on one of the information recording layers of the recording medium; and
a signal processing circuit which acquires a component containing characteristics peculiar to the information recording layer of the recording medium having the second recording density out of the reflected light detected by the photodetector, and thereby identifies the recording density of the recording medium.

2. The optical disc drive according to claim 1, wherein
the wavelength of the light output from the light source is a wavelength used to reproduce information from the recording medium having the first recording density.

3. The optical disc drive according to claim 1, wherein
the photodetector includes two detection areas split by a splitting line settled along a radial direction of the recording medium, and outputs a difference between outputs of the two detection areas of the photodetector when the lens is condensing the light on one of the information recording layers of the recording medium.

4. The optical disc drive according to claim 1, wherein
the lens is movable by a predetermined distance in a radial direction of the recording medium in the case where the photodetector includes at least two detection areas split by splitting lines settled along the radial direction of the recording medium and along a direction perpendicular to the radial direction, and outputs a difference between outputs of the two detection areas of the photodetector when the lens is condensing the light on one of the information recording layers of the recording medium.

5. The optical disc drive according to claim 1, wherein
the signal processing circuit is configured to eliminate the influence of a change in the thickness of an intermediate layer set between the information recording layers of the recording medium in the case where the photodetector includes at least two detection areas split by a splitting line in a radial direction of the recording medium, and outputs a difference between outputs of the two detection areas of the photodetector when the lens is condensing the light on one of the information recording layers of the recording medium.

6. A method of identifying the types of recording media of two or more standards different in recording density, the method comprising:
locating, at a predetermined position in a radial direction of the recording medium, an actuator holding a lens which condenses light from a light source on a predetermined one of two or more information recording layers of the recording medium;
moving the lens to a position at a predetermined distance from the recording layer of the recording medium, and then moving the lens toward the recording layer of the recording medium by a predetermined distance;
detecting a condition where a distance between the lens and the recording layer of the recording medium coincides with a focal distance of the lens;
detecting reflected light from the recording layer by use of a photodetector including a light receiving area divided into two in the radial direction of the recording medium, and finding the outputs of the light receiving area and a difference between the two outputs; and
identifying the recording medium as a recording medium having a high recording density when a ratio between the difference and the sum of the outputs is less than or equal to a predetermined value.

7. The method according to claim 6, wherein
when the ratio between the difference and the sum is greater than the predetermined value, the lens is moved in the radial direction of the recording medium within a range of a given condition, and the recording medium is identified as a recording medium having the high recording density at a point where the ratio between the difference and the sum is less than or equal to the predetermined value.

8. The method according to claim 6, wherein
when the ratio between the difference and the sum is greater than the predetermined value, the reflected light from the recording layer of the recording medium is detected by the photodetector for at least one round of the recording medium at the same position in the radial direction of the recording medium, and the recording medium is identified as a recording medium having the high recording density at a point where the ratio between the difference and the sum is less than or equal to the predetermined value.

9. The method according to claim 6, wherein
when the ratio between the difference and the sum is greater than the predetermined value, the reflected light from the recording layer of the recording medium is detected by the photodetector for at least one round of the recording medium at the same position in the radial direction of the recording medium, and the recording medium is identified as a recording medium having the high recording density at a point where a result of comparing the ratio with a second predetermined value is detected to be less than or equal to the second predetermined value.

10. A device which identifies the types of recording media of two or more standards substantially equal in the distance to an information recording layer but different in recording density, the device comprising:
a photodetector which has two light receiving areas in a radial direction of the recording medium having at least two information recording layers provided with a first recording density or a second recording density higher than the first recording density;
an actuator which integrally holds a light source, a lens to provide predetermined condensing properties to light from the light source, and the photodetector and which moves at least the lens in two directions including a direction perpendicular to the recording layer of the recording medium and the radial direction; and
a signal processing circuit which specifies whether the recording density of the individual information recording layer of the recording medium is the first recording density or the second recording density in accordance with an output corresponding to the light from the light source reflected by the recording layer of the recording medium detected by the photodetector.
